(19) United States
(12) Patent Application Publication
(10) Pub. No.: US 2026/0242063 A1
(43) Pub. Date: Aug. 20, 2026

(54) AN AIRCRAFT CABIN

(71) Applicant: SINGAPORE AIRLINES LIMITED, Singapore (SG)

(72) Inventor: Yung Han NG, Singapore (SG)

(73) Assignee: SINGAPORE AIRLINES LIMITED, Singapore (SG)

(21) Appl. No.: 18/879,027

(22) PCT Filed: Jun. 27, 2022
(86) PCT No.: PCT/SG2022/050434

§ 371 Date: Dec. 26, 2024

(51) Int. Cl. B64D 11/06; B64D 11/00

(52) U.S. Cl. CPC B64D 11/0604; B64D 11/003; B64D 11/0606; B64D 11/0638; B64D 11/064; B64D 11/0641; B64D 11/0644

(57) ABSTRACT

A double bed compartment for an aircraft cabin and an aircraft cabin that comprises the double bed compartment are also disclosed. The double bed compartment has two passenger doorways and two passenger chairs positioned side-by-side adjacent each other. In some embodiments, the double bed compartment has an upright privacy screen movable between retracted and deployed positions. In the deployed position the privacy screen forms a wall dividing the double bed compartment into separate individual compartments each accessible via one of the doorways. In some embodiments, each passenger chair is movable independently of the other chair or the pair of chairs are movable together in tandem. In some embodiments, the double bed compartment has walls along aisles of the aircraft cabin, with the walls defining the two doorways, and the walls being outwardly curved and forming two areas on which passengers can stand between the chairs and the doorways.

### FIELD OF THE INVENTION

The invention relates to a passenger compartment in an aircraft.

The invention relates to an aircraft cabin with at least one passenger compartment.

It is noted that the terms “aircraft”, and “aeroplane” and “plane” are used interchangeably herein.

### BACKGROUND OF THE INVENTION

Commercial aircraft cabins contain passenger compartments, such as those found in first class cabins.

International application PCT/SG2005/000042 (WO2005/080196), which is incorporated herein by reference, in the name of the applicant discloses one such aircraft cabin with passenger compartments.

WO2005/080196 discloses an aircraft cabin having outer and inner rows of passenger compartments, the compartments in each row being spaced apart in a length-wise extending direction of the aircraft. Each compartment comprises walls that define a compartment space and are accessible via a doorway in one of the walls, with each compartment comprising a chair and a separate bed for a passenger. The bed is a bifold configuration that can be stowed within a cavity in the walls of the compartment when not in a bed configuration position within the compartment. The outer rows are separated from the inner rows by length-wise extending aisles. The outer rows are positioned along opposite sides of the aircraft, with the aircraft side walls forming sections of compartment walls for these rows. The inner row includes at least one pair of adjacent passenger compartments, each compartment of the pair having a separate doorway providing access to the adjacent aisle.

WO2005/080196 discloses that the at least one pair of adjacent compartments in the inner row may be combined to form a double bed compartment option for passengers. The beds in each compartment of the pair are positioned to form a double bed when the compartments are in a double compartment configuration.

More particularly, WO2005/080196 discloses that the at least one pair of compartments are separated by a partition wall that extends upwardly from a floor of the compartment to approximately waist height. Located above this partition wall is a top rail and a retractable blind housed in the top rail. The blind can be pulled down to be positioned between the compartments to engage with a part of the partition wall to completely separate the compartments into two single compartments. The blind can also be retracted into the top rail so that the compartments can be converted from two separate compartments into a double bed compartment.

International application PCT/SG2017/050475 (WO2019/059841), which is incorporated herein by reference, in the name of the applicant discloses another aircraft cabin that includes passenger compartments, including a double bed compartment option for passengers.

WO2019/059841 discloses an aircraft cabin having outer and inner rows of passenger compartments, the compartments in each row being spaced apart in a length-wise extending direction of the aircraft. Each compartment comprises walls that define a compartment space and are accessible via a doorway in one of the walls, with each compartment comprising a chair and a separate bed for a passenger. The outer rows are positioned along opposite sides of the aircraft, with the aircraft side walls forming sections of compartment walls for these rows. The inner row includes at least one pair of adjacent passenger compartments, each compartment of the pair having a separate doorway providing access to the adjacent aisle.

Each compartment includes a storage cassette for storing the bed in a vertical orientation along a longer edge of the bed in the stowed position, with the bed being moveable between the stowed position in the cassette and the operative position in which the bed defines the sleeping platform within the passenger space.

The double compartment option of WO2019/059841 comprises two of the above-described compartments separated by a common perimeter wall section between the compartments.

The common wall is an extendible/retractable wall such that the wall can be extended or retracted vertically between an upwardly-extended position and a retracted position. The beds of the compartments are positioned against the common wall. When the extendible/retractable wall is in the retracted position, the beds can be moved from the stowed positions to the operative positions and in the operative positions define a double bed arrangement.

The present invention provides an alternative to the passenger compartments disclosed in WO2005/080196 and WO2019/059841.

The above description is not to be taken as an admission of the common general knowledge.

### SUMMARY OF THE DISCLOSURE

The invention provides an aircraft cabin comprising a plurality of passenger compartments including at least one double bed passenger compartment, with the double bed compartment being defined by a perimeter wall having two openings to allow access to and from the double bed compartment, two passenger chairs positioned side-by-side adjacent each other, and an upright privacy screen which is movable between (a) a retracted position in which the privacy screen is stowed at least substantially outside the double bed compartment so that passenger movement in the compartment is not restricted by the privacy screen and (b) a deployed position in which the privacy screen is in the double bed compartment between the passenger chairs and divides the compartment into two separate individual passenger compartments, with the privacy screen forming a common wall between the separate individual compartments, and with each separate individual compartment being accessible via one of the openings.

Unlike the double bed compartments of W02005/080196 and WO2019/059841, the double bed compartment described in the preceding paragraph does not require a partition wall which would otherwise occupy valuable floor space and restrict passenger movement within the double bed compartment. As such, more floor space can be utilised when the privacy screen is in the stowed position.

When deployed, the privacy screen ensures passenger privacy in the two separate individual passenger compartments.

When stowed, the absence of the privacy screen altogether from the double bed compartment creates a fully integrated passenger space for two passengers. Each integrated space is completely accessible by the passengers within the space. Specifically, when the chairs are not in a bed configuration, passengers can walk from one from one side of the integrated space to the other side.

The privacy screen, unlike the privacy screens of the compartments of WO2005/08196 and WO2019/059841, which are movable vertically, is movable horizontally between the retracted position that is at least substantially outside the double bed compartment and the deployed position in which the privacy screen is in the double bed compartment between the passenger chairs. In practice, typically (although not necessarily) this means that the privacy screen moves forwardly and rearwardly from and to the stowed retracted position in the lengthwise-extending direction of the aircraft.

The perimeter wall may include a cavity for receiving and thereby stowing the privacy screen in the retracted position.

The cavity may be positioned rearwardly of the passenger chairs. However, the invention is not confined to this orientation and by way of example it is also envisaged that the cavity could be positioned forwardly of the passenger chairs.

The privacy screen may comprise a plurality of upright panels that can move independently of each other between the retracted and the deployed positions.

In the retracted position, the panels may be arranged in an overlapping arrangement, i.e. with the panels in a side-by-side arrangement, with a face of one panel facing a face of an adjacent panel, outside the double bed compartment.

In the deployed position, the panels may be arranged in an end-to-end arrangement, i.e. with side edges of adjacent panels in contact, with each panel occupying a section of the common wall between the separate individual compartments.

The privacy screen may comprise a plurality of upright panels that are interconnected and can telescope between the retracted and the deployed positions.

The height of the perimeter wall may be any suitable height.

By way of example, the height may be in a range of 1.5-1.9 m, typically 1.7 m.

The privacy screen may extend to the height of the perimeter wall adjacent the privacy screen.

However, the invention is not confined to this arrangement and by way of example it is also envisaged that the privacy screen may extend to a height less than or greater than the height of the perimeter wall.

The passenger compartment may include at least one rail for supporting and guiding the privacy screen for movement between the retracted and deployed positions between the passenger chairs.

The rail may be positioned at the height of the perimeter wall adjacent the privacy screen.

The passenger compartment may include at least one lower rail that is located on a floor of the compartment. Suitably, the lower rail is recessed into the floor such that it does not form a trip hazard to passengers.

The privacy screen may be operated electrically.

Alternatively, the privacy screen may be operated manually.

The invention also provides an aircraft including the above-described double bed passenger compartment.

The invention also provides a double bed passenger compartment for an aircraft, the double bed compartment being defined by a perimeter wall having two openings to allow access to and from the double bed compartment, two passenger chairs positioned side-by-side adjacent each other, and an upright privacy screen which is movable between (a) a retracted position in which the privacy screen is stowed at least substantially outside the double bed compartment so that passenger movement in the compartment is not restricted by the privacy screen and (b) a deployed position in which the privacy screen is in the compartment between the passenger chairs and divides the double bed compartment into two separate individual passenger compartments, with the privacy screen forming a common wall between the separate individual compartments, and with each separate individual compartment being accessible via one of the openings.

The invention also provides an aircraft cabin comprising a plurality of passenger chairs including at least one pair of passenger chairs positioned side-by-side adjacent each other, each passenger chair of the pair being adjustable between an upright position and a reclined position, each passenger chair of the pair being separately operable by a passenger to adjust the position of the chair independently of the other chair of the pair, and the pair also being operable together such that the position of the pair of chairs can be adjusted simultaneously so that both chairs move in tandem.

It is noted that the arrangement described in the preceding paragraph is not confined to aircraft cabins having a double bed passenger compartment.

The arrangement described in the two paragraphs above this paragraph provides passengers with flexibility as to how they wish to operate the chairs. The passenger chairs of the pair can be separately-operated or they can be operated in tandem such that one passenger (for example) can operate both chairs so that the chairs move together to the same angle of inclination. This option for tandem operation means that one passenger does not have to separately adjust his/her chair to match the angle of the other passenger's chair in the pair of chairs.

The angle adjustment of the passenger chairs in the pair may be remotely operated via a remote controller.

Suitably, the remote controller can independently adjust the angle of each passenger chair. The remote controller may comprise a single controller. Alternatively, the remote controller may comprise a plurality of controllers. The remote controller may comprise a wall mounted control panel. The control panel may be positioned on the perimeter wall of the compartment. The remote controller may comprise a hand-held controller. The hand-held controller may be a wireless unit.

The passenger chair may have an inner arm rest and an outer arm rest and at least one of the inner and outer arm rests is height adjustable.

The terms “inner” and “outer” are understood herein to refer to a position in relation to an aisle. For example, an “outer arm rest” is an arm rest of each chair positioned closer to the adjacent aisle to the compartment.

When the passenger chairs are in the upright position, the inner arm rests can be lowered to form a two-seater sofa configuration.

The term “two-seater sofa configuration” is understood herein to mean an equivalent of a two-seater sofa formed from the chairs.

When the passenger chairs are in the reclined position, the inner and outer arm rests can be lowered to form a double bed configuration.

The term “double bed configuration” is understood herein to mean an equivalent of a double bed formed from the chairs.

At least one of the inner and the outer arm rests may be electrically operated, for example, via an electric motor.

Alternatively, at least one of the inner and the outer arm rests may be pneumatically-operated. This may be achieved through the operation of an air compressor or via controlled release of compressed air from a storage tank to inflate an expandable bladder, such as a balloon or a bag, inside the arm rest.

Alternatively, at least one of the inner and the outer arm rests may be hydraulically-operated. This may be achieved through the operation of a pump to pump fluid into an expandable bladder, such as a balloon or a bag, inside the arm rest.

The height of at least one of the inner and the outer arm rests may be adjustable via the remote controller.

At least one of the chairs may have a backrest comprising a middle section and lateral wing sections pivotably connected to the middle section, such that the curvature of the backrest is adjustable.

The lateral wing sections may be inflatable through the operation of an air compressor or via controlled release of compressed air from a storage tank to inflate an expandable bladder, such as a balloon or a bag, inside lateral wing sections.

Alternatively, the expandable bladder may by injected with a fluid to expand the bladder. In other words, the expandable bladder may be hydraulically operated.

The above described backrest arrangement is suitable for providing both a flat surface when in the double bed configuration and a curved surface when in the upright position.

The passenger compartment may comprise an ottoman having a seat.

The term “ottoman” is understood herein to mean an upholstered seat, typically but not necessarily without a back or arms, and typically but not necessarily configured to define a storage space with the seat hinged to form a lid to close the storage space.

The ottoman and the chair may be configured to define a bed when the chair is in a bed configuration.

The ottoman may include a space for storing luggage.

The space may be located on an underside of a seat of the ottoman.

The ottoman seat may be upwardly movable to allow access to the storage space.

Typically, the ottoman is separate from the chair and located in front of and spaced from the chair. The seat of the ottoman can be lifted upwardly to reveal the cabin luggage storage space beneath the seat. A passenger can access the storage space even while seated in the chair with a safety belt in an operative position. This design maximises storage space and retains a tidy and minimalist design.

The ottoman seat can also function as a “partner” seat that allows passengers to dine facing each other when the table is also deployed, with one passenger in the chair and the other passenger on the ottoman. When the privacy screen is retracted, as many as four passengers can enjoy dining together.

The passenger compartment may comprise a table that is movably connected to an arm that projects from the perimeter wall. Suitably the table may be slidable along rails on the arm.

An advantage of the table is that the table is connected to the perimeter wall as opposed to the floor or the chair. This means that when the table is collapsed, there is no obstruction that would prevent a passenger from walking within the compartment.

In some embodiments, the arm is telescopically movable.

The table may be in several sections that are connected together so that the table is foldable form a compact table assembly to an expanded table assembly.

The invention also provides an aircraft including the above-described pair of passenger chairs positioned side-by-side adjacent each other.

The invention also provides an aircraft cabin comprising:
(a) at least two outer rows of passenger compartments on each side of the aircraft cabin, with each row being spaced apart in a length-wise extending direction of the aircraft cabin, with the aircraft side walls forming a section of the compartments of each row,
(b) at least one inner row of two adjacent passenger compartments,
(c) at least two aisles extending in the length-wise extending direction and separating the compartments in each row so that each compartment is accessible via one of the aisles, and
(d) with each compartment comprising walls that define a compartment space and a doorway that allows access to the compartment space from one of the aisles, with each compartment at least comprising a chair for a passenger that is configured to function as a chair and as a bed, and with the walls along the aisles being outwardly curved walls that form an area between the chair and the doorway on which a passenger can stand when the chair is in a bed configuration.

It is noted that the arrangement described in the preceding paragraph is not confined to aircraft cabins having a double bed passenger compartment.

Each compartment may include a door that is movable between a closed position in which the door extends across and closes the doorway and an open position in which the door is away from the doorway.

The doorways of the compartments on opposite sides of the aisles may not be aligned whereby the doorways face the doorway walls on opposite sides of the aisles.

### BRIEF DESCRIPTION OF DRAWINGS

The invention is described further by way of example only with reference to the accompanying drawings of which:

FIG. 1 is a general layout diagram of one embodiment of an aircraft cabin in accordance with the invention comprising one embodiment of a passenger compartment in accordance with the invention, noting that the invention is not confined to these embodiments;

FIG. 2 is an external perspective view of the passenger compartment shown in FIG. 1 with a privacy screen in a deployed position;

FIG. 3 is an external perspective view of the passenger compartment shown in FIG. 1 with the privacy screen in a stowed position;

FIGS. 4A and 4B are external perspective views of the passenger compartment shown in FIG. 1 with the privacy screen in partially deployed positions;

FIG. 5 is an internal perspective view of the passenger compartment shown in FIG. 1 with the privacy screen in the stowed position;

FIG. 6A is a front perspective view of a passenger chair shown in FIG. 1 with a backrest defining a flat surface;

FIG. 6B is a front perspective view of a passenger chair shown in FIG. 1 with the backrest defining a curved surface;

FIG. 7A is a perspective view of the passenger compartment shown in FIG. 1, with a table in the stowed position;

FIG. 7B is a perspective view of the passenger compartment of FIG. 1, with both tables in the deployed and folded position;

FIG. 7C is a perspective view of the passenger compartment of FIG. 1, with both tables in the deployed and unfolded position; and

FIG. 8 is a perspective view of an outer row suite passenger compartment shown in FIG. 1, with the table in the deployed and unfolded position.

### DETAILED DESCRIPTION OF SPECIFIC EMBODIMENTS

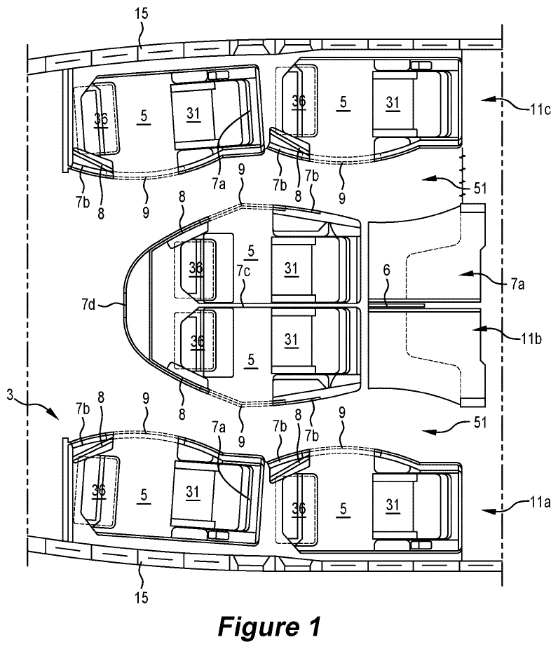

FIG. 1 shows an aircraft cabin 3 comprising a plurality of passenger compartments 5 that define multi-functional compartment spaces for passengers.

The compartments 5 are designed so that the compartments can be completely enclosed so that passengers can have total privacy.

The compartments 5 are designed particularly, although not exclusively, for long-haul flights during which the passengers occupying the compartments may wish to work, relax, or sleep.

The cabin comprises outer rows 11a, 11c of compartments 5, an inner row 11b comprising a double bed compartment option formed from two adjacent compartments 5, with the compartments 5 of each row being spaced apart in a length-wise extending direction of the aircraft, and with the rows separated by length-wise extending aisles 51.

It is noted that the invention is not confined to the numbers of compartments 5, the numbers of rows 11a, 11b, 11c, and the numbers of aisles 51 shown in the Figures.

The compartments 5 of each row 11a, 11b, 11c are accessible via openings in the form of doorways 9 in the walls 7b, hereinafter referred to as “doorway walls 7b”, that define the aisles 51.

The doorways 9 are centrally positioned in the doorway walls 7b and divide the walls 7b into two equal sized sections, one on each side of the walls 7b. It is noted that the invention is not confined to this arrangement of a centrally-located doorway.

The two outer rows 11a, 11c of compartments 5 are positioned along opposite sides of the aircraft. The aircraft side walls 15 form outer side walls of the compartments 5. The compartments 5 in each outer row 11a, 11c also include walls 7a that extend inwardly from the aircraft side walls 15. The walls 7a form end walls of the compartments 5. The doorway walls 7b extend from the end walls 7a and form interior side walls of the compartments 5. Collectively, the aircraft side walls 15, the walls 7a and the doorway walls 7b form a perimeter wall of each compartment 5.

Each end wall 7a and the sections of the doorway walls 7b that extend in opposite directions from the end walls 7a are essentially T-shaped arrangements.

The inner row 11b of compartments 5 comprises a pair of the compartments 5 in side by side relationship. These compartments 5 have a curved forward wall 7d, doorway walls 7b, and an end wall 7a that collectively define a perimeter wall of the compartment 5. The doorway walls 7b are bowed outwards towards the aircraft side walls 15. The compartments 5 in each pair have doorways 9 that open into aisles 51 on opposite sides of the internal row 11b. The curved forward wall 7d and bowed door walls 7d result in an egg-shaped appearance of the compartments 5 when viewed in plan.

It is noted that the aircraft cabin 3 may comprise more than one inner row 11b of a pair of compartments 5, with such pairs of compartments being spaced in the length-wise extending direction of the aircraft.

The compartments 5 in the inner row 11b are identical to the compartments 5 in the outer rows 11a and 11c in terms of furniture and layout save that the outer rows 11a, 11c have a different table assembly (which will be explained later in the specification).

The compartments 5 in the inner row 11b are separated by an upright privacy screen 7c that can be moved horizontally between a deployed position within the compartments 5 and a retracted position within a cavity 6 (also described as a “slot”—see FIG. 1 and other Figures) that is outside the compartments 5, as described further below, so that the compartments 5 can be converted from separate single compartments 5 into an open double bed compartment.

It is noted that the invention extends to arrangements in which the compartment layouts in the rows 11a, 11b, 11c are different to that shown in the Figures.

The walls 7a, 7b, 7d are any suitable height that ensures privacy of passengers in the compartments 5. For example, the walls 7 a, 7 b, 7 d are 1.7 m high.

The aisles 51 are formed as curved aisles. The curved aisles contribute to the overall appearance of the cabin. The curved aisles 51 are formed by forming the doorway walls 7b as convex walls as viewed from the aisles 51 and by staggering positions of the compartments 5 so that the doorways 9 of the compartments 5 on opposite sides of the aisles 51 are not aligned.

The compartments 5 in the rows 11a, 11b, 11c are staggered along the length of the aisles 51 so that the doorways 9 of the compartments on one side of the aisles 51 face the doorway walls 7b on the other side of the aisles 51, and vice versa.

As is indicated above, forming the doorway walls 7b as curved walls as viewed from the aisles 51 means that there is additional space in these sections of the compartments 5 as described further below. This is an advantage because it makes it possible to make more efficient use of the available space within the compartments 5.

Each compartment 5 comprises a sliding door assembly for closing the doorway 9. The sliding door assembly of each compartment 5 comprises a door 8 that is mounted for sliding movement between a retracted position in which the door 8 is located in the frame (not shown) in the doorway wall 7b and a closed position in which the door 8 extends across the doorway 9 to close the compartment 5. In the closed position, the door 8 and the doorway walls 7b are curved outwardly into the respective aisle 51. By curving the door 8 outwardly, additional space is created within the compartment 5. This additional space is useful as when the doors are closed and the chair 31 is reclined in a bed configuration (as is described further below), there is a space between the bed and the closed door 8 that allows the passenger to stand or comfortably place his/her legs to stand aside the bed configuration.

Each door 8 has fixed louvers.

Each passenger compartment 5 houses an extensive range of furniture required by passengers, particularly on long-haul flights.

The furniture comprises the above-mentioned chair 31, an ottoman 36 having a seat, and a table assembly 38 located within the compartment 5.

The furniture is designed and arranged to be interactive so that the furniture can be selectively arranged in a number of different functional configurations as may be required by passengers, particularly on long-haul flights.

The chair 31 is located to one side of the doorway and is positioned against the end wall 7a on that side of the doorway 9, the ottoman 36 is located to the other side of the doorway 9, the table assembly 38 is housed in the end wall 7a proximate the ottoman 36 and is movable between a storage position in which the table is stored within a cavity in the end wall 7a and an operative position in which the table assembly 38 extends horizontally into a space between the chair 31 and the ottoman 36. The table assembly 38 is positioned adjacent the aircraft side walls 15 in the case of the outer rows 11a and 11c of the compartments 5. The table assembly 38 is positioned adjacent the forward wall 7d on that side of the doorway 9 in the case of the inner row 11b of the compartments 5.

The ottoman 36 has a space for storing luggage located on an underside of the seat of the ottoman 36. The seat can be lifted upwardly to reveal luggage stored in the space.

The chair 31 is multi-functional. Specifically, the chair 31 is foldable between an upright position, suitable for a person to sit in the chair 31, and a fully reclined position, in which the chair 31 forms a bed. It is noted that the chair 31 can be adjusted to any position between the upright and the fully reclined positions.

In some embodiments, the ottoman 36 can be abutted with the end of the bed to extend the length of the bed. In this regard, the ottoman 36 has a top surface that is at the same elevation as a top surface of the bed in order to provide an even surface for lying on.

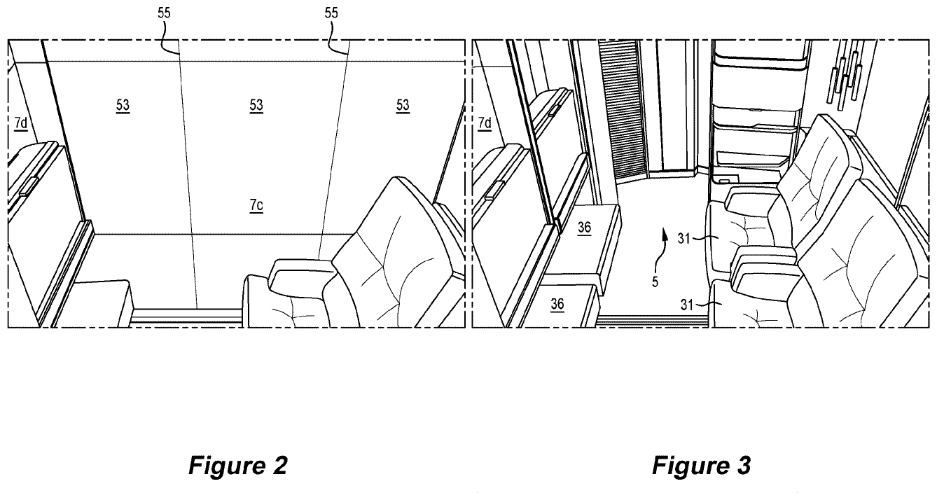

FIGS. 2 to 4 show an internal view of the pair of the compartments 5 in the internal row 11b.

In FIG. 2, the compartments 5 in the pair are separated by the upright privacy screen 7c comprising three independently movable, i.e. individual, upright panels 53 in the above-mentioned deployed position within the compartments 5. In this position, the panels 53 form the continuous privacy screen 7c shown in the Figure that separates the compartments 5 in the pair. In other words, in this position, the panels 53 are arranged end-to-end, i.e. with side edges 55 of adjacent panels in contact, with each panel 53 occupying a section of a common wall between the compartments 5. Each panel 53 extends the entire perimeter wall height, i.e. 1.7 m. The privacy screen 7c ensures that the passengers in the pair of compartments 5 are obscured from view from each other and do not have access across the compartments 5 when the privacy screen 7c is in the deployed position. The privacy screen 7c also acts as an acoustic barrier when the privacy screen 7c is in the deployed position. In this regard, the privacy screen 7c may include sound dampening material to further attenuate noise travelling between the compartments.

As noted above, the upright privacy screen 7c can be moved from the deployed position within the compartments 5 to the retracted position outside the compartments 5 so that the compartments 5 can be converted from separate single compartments into a larger double bed compartment. In the double bed compartment configuration, the privacy screen 7c does not restrict movement within the larger double bed compartment.

The panels 53 of the privacy screen 7c are movable horizontally independently of each other via an electrical drive system (not shown) between the deployed position (as shown in FIG. 2) and the retracted position in the cavity 6 (see FIG. 1 and other Figures). In the retracted position, the panels 53 are arranged in an overlapping arrangement, i.e. with the panels 53 in a side-by-side arrangement, with a face of one panel 53 facing a face of an adjacent, overlapping, panel 53.

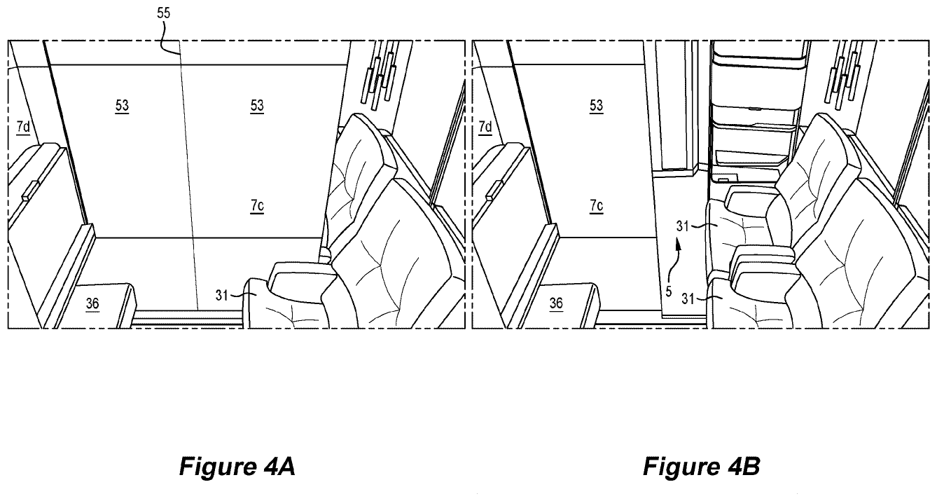

FIGS. 4A and 4B show the privacy screen 7c in two partially deployed configurations. These partially deployed configurations provide the passengers some level of privacy to the passenger in the opposing compartment. For example, in FIG. 4A, the passenger in one compartment 5 is obstructed from viewing the passenger in the other compartment 5 from the waist downwards. In FIG. 4B the passenger in one compartment 5 can visually observe the passenger in the other compartment 5 but is obstructed from viewing a screen positioned on a front wall of the compartment 5.

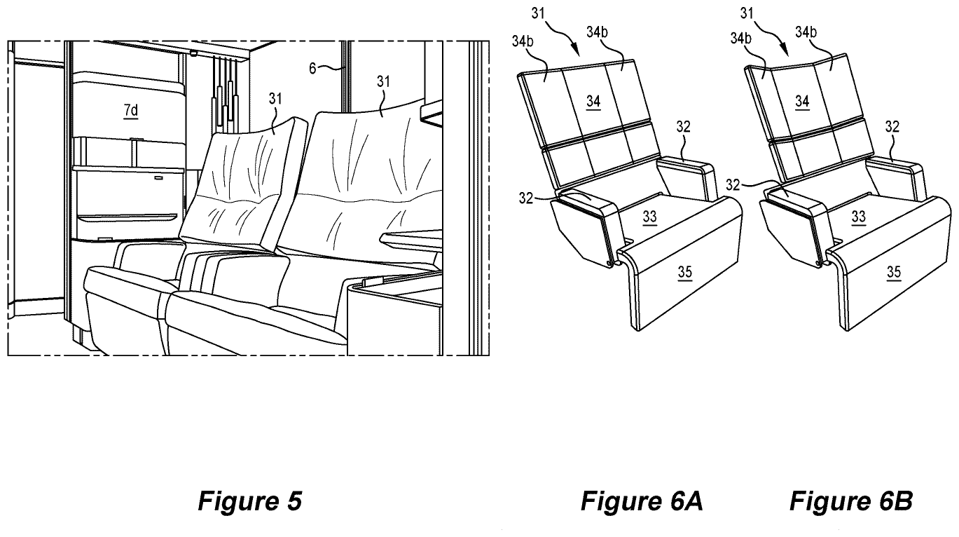

FIGS. 3 and 5 show the compartments 5 with the privacy screen 7c in the retracted position in the cavity 6 located in a part of the end wall 7a positioned behind the chair 31.

The cavity 6 is an elongate slot (and is referred to hereinafter as slot 6) that extends the entire cabin height, i.e. 1.7 m. The depth of the slot 6 is determined by the depth of the panels that form the privacy screen 7c. In other words, the slot 6 must be deep enough to accommodate a single panel without the panel protruding out of the slot 6. The width of the slot 6 is determined by the maximum thickness of the panel located nearest the slot 6. Preferably, each panel of the privacy screen 7c has the same thickness.

However, it is also envisaged that the thickness of the panels may be less for panels further away from the slot 6 than those closer to the slot when the privacy screen is in the deployed position. For example, a terminal panel located furthest away from the slot 6 in the deployed position may have the smallest thickness. In some forms of the privacy screen 7c (not shown in the Figures), the variation in thickness allows the panels of the privacy screen 7c to be telescoped within each other when retracted into the stowed position. As such, each panel, except for the terminal panel, needs to have a thickness large enough to accommodate its adjacent panel.

The privacy screen 7c moves along and between a pair of rails 10 via an electrical drive system (not shown). The pair of rails 10 is located at the cabin height (i.e. 1.7 m) and extend between the passenger chairs 31.

The privacy screen 7c is operated electrically via a remote controller. The remote controller may be a hand held remote controller or a wall mounted control panel.

FIGS. 6A and 6B show an illustration of the chair 31 used in each of the passenger compartments 5. The chair 31 is pivotably adjustable between an upright position (as shown in FIGS. 6A and 6B) and a fully reclined position (not shown) and any suitable position therebetween. In the reclined position, the chair 31 becomes a bed suitable for the passenger to lie flat.

Adjacent passenger chairs 31 are pivotably connected such that adjusting an angle of one passenger chair 31 simultaneously adjusts an angle of the other passenger chair 31. When adjacent passenger chairs 31 are operated in tandem, as described above, the partner of the passenger can adjust the angle of both chairs 31 simultaneously. This configuration prevents the partner of the passenger having to carefully adjust his/her chair 31 to match the angle of his/her partner's chair 31.

The angle adjustment of the passenger chairs 31 is remotely operated via a remote controller. The remote controller may have a secondary mode of operation whereby the angle of each passenger chair 31 can be adjusted independently. It is preferable that this remote controller is the same remote controller used to operate the privacy screen 7c. However, it is also conceivable that the remote controller may be a different remote controller.

It is desirable, for safety reasons, that the cabin crew have access to the remote controller and are able to select which mode of operation, i.e. tandem or independent angle adjustment, the chairs 31 are operated in. For take-off and landing the chairs 31 must be in the upright position. As such, the cabin crew may wish to override the control of the chairs 31 to return all, or some, of the chairs 31 to the upright position.

Each passenger chair 31 has a pair of arm rests 32. The arm rests 32 are electrically actuated such that the height of each arm rest is adjustable. When a pair passenger chairs 31 are in the upright position, the arm rests located in-between the chairs 31 (the inner arm rests) can be lowered to form what is equivalent to a “two-seater sofa” configuration from the pair of adjacent chairs. When the pair of passenger chairs are in the reclined position, the arm rests located closest to the privacy screen 7c (the outer arm rests) can be lowered to form what is equivalent to a “double bed” configuration from the pair of adjacent chairs.

The height of at least one of the arm rests 32 is adjustable via a remote controller. It is preferable that this remote controller is the same remote controller used to operate the angle of the chairs. However, it is also conceivable that the remote controller may be a different remote controller.

Each chair 31 has a seat 33, a backrest 34 and a leg rest 35.

The backrest 34 comprises a middle section 34a with lateral wings 34b pivotably connected to the middle section. The lateral wings 34b allow the curvature of the backrest to be adjustable, as shown in FIGS. 5A and 5B. It is desirable to provide a flat surface when the chair 31 is in the “double bed” configuration and curved surface when the chair 31 is in the upright position.

Each chair 31 also has a leg rest 35 that is pivotably connected to a base of the chair 31. When the chair 31 is in the upright position, as shown in FIGS. 5A and 5B, the leg rest 35 is approximately perpendicular to the base of the chair 31 such that it is tucked underneath the passenger's legs. However, when the chair 31 is in the reclined position, a top surface of the leg rest 35 is flush with the seat 33 and the backrest 34.

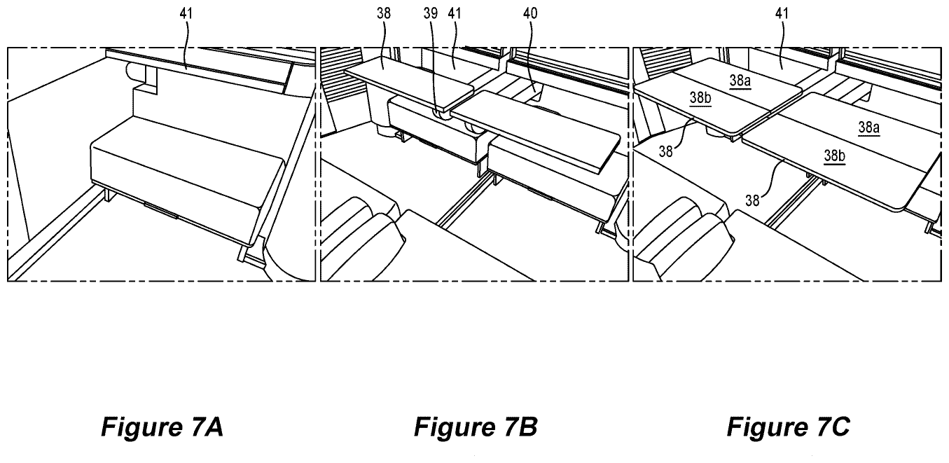

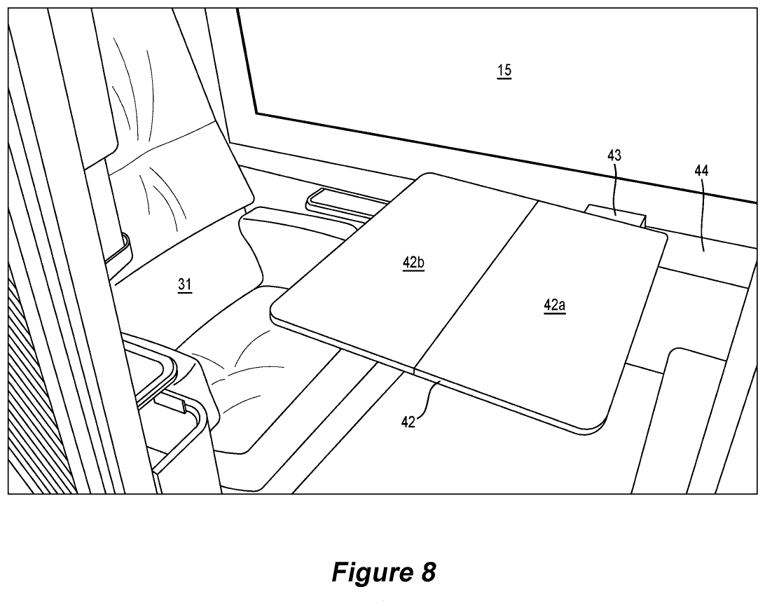

As shown in FIGS. 7A to 7C, each of the inner row 11b compartments 5 has a table assembly 38 connected to an arm 39 via a bracket 40.

The arm 39 has a proximal end that is connected to the forward wall 7d and a distal end which is connected to the bracket 40. The arm 39 is telescopically extendable in a first direction along a first axis which extends between adjacent seats.

The arm 39 extends from the end wall 7a and not the floor. This configuration minimises obstructions, when the table assembly 38 is in the stowed configuration, that would otherwise form a trip hazard to passengers walking across the floor.

The bracket 40 comprises a bottom section which is fixedly connected to the distal end of the arm 39, such that the bracket 40 is movable with the arm 39 as it extends in the first direction along the first axis.

The table assembly 38 is a bifold table comprising two table leaves 38a, 38b that are hinged together, such that the leaves are pivotably movable about a second axis that is perpendicular to the first axis.

As can be seen in FIG. 7A, a Portion of the Forward wall 7d in front of the chairs 31 comprises a horizontally extending elongate slot which defines a storage pocket 41. The storage pocket 41 is dimensioned such that the table assembly 38 can be fully retracted within the storage pocket 41 in the stowed configuration.

In a deployed configuration, the table assembly 38 is configured to support food and other items.

The table assembly 38 can be transitioned from the stowed configuration to the deployed configuration electrically via a remote controller. Alternatively, the table assembly 38 can be transitioned from the stowed configuration to the deployed configuration manually.

To transition the table assembly 38, the bracket 40 is extended in a first direction along a first axis to position the table assembly 38 between the chair 31 and the ottoman 36, which results in the arrangement shown in FIG. 7B. One of the table leaves 38a, 38b can then be pivoted about the second axis to unfold the table assembly 38, which results in the arrangement shown in FIG. 7C.

As shown in FIG. 8, each of the outer row 11a, 11c compartments 5 has a table assembly 41 comprising a table 42 having two table leaves 42a, 42b that are hingedly connected to each other. The table 42 is connected to an arm 43 which is slidably mounted to a bracket 44. The bracket 44 is mounted along the aircraft side wall 15. To stow the table assembly 41, the passenger folds the table leaves 42a, 42b and slides the table assembly 41 forwards into a storage pocket located in front of the seat 31 in the compartment.

This configuration similarly minimises obstructions, when the table assembly 41 is in the stowed configuration, that would otherwise form a trip hazard to passengers walking across the floor.

In summary, the aircraft cabin according to the invention optimises space utilisation, enhances the experience of luxury and minimises the amount of trip hazards within the passenger compartments.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1-28. (canceled)

29. An aircraft cabin comprising a plurality of passenger chairs including at least one pair of passenger chairs positioned side-by-side adjacent each other, each passenger chair of the pair being adjustable between an upright position and a reclined position, each passenger chair of the pair being separately operable by a passenger to adjust the position of the chair independently of the other chair of the pair, and the pair also being operable together such that the position of the pair of chairs can be adjusted simultaneously so that both chairs move in tandem to the same angle of inclination.

30. The aircraft cabin of claim 29, wherein the angle adjustment of the passenger chairs is remotely operable via a remote controller.

31. The aircraft cabin of claim 30, wherein the remote controller can simultaneously adjust the angle of the pair of passenger chairs.

32. The aircraft cabin of claim 30, wherein the remote controller can independently adjust the angle of each passenger chair.

33. The aircraft cabin of claim 29, wherein each passenger chair has an inner arm rest and an outer arm rest and at least one of the inner and outer arm rests is height adjustable, wherein the height of at least one of the inner and the outer arm rests is adjustable via a remote controller.

34. The aircraft cabin of claim 33, wherein when the passenger chairs are in the upright position, the inner arm rests can be lowered to form a two-seater sofa configuration, or wherein when the passenger chairs are in the reclined position, the inner and outer arm rests can be lowered to form a double bed configuration.

35. The aircraft cabin of claim 29, wherein at least one of the chairs has a backrest comprising a middle section with lateral wings pivotably connected to the middle section, such that the curvature of the backrest is adjustable.

36. The aircraft cabin of claim 29, further comprising an ottoman.

37. The aircraft cabin of claim 36, wherein the ottoman has a hinged seat and a space for storing luggage, wherein the hinged seat can be raised to reveal luggage stored in the storage space.

38. The aircraft cabin of claim 29, further comprising a table that is movably connected to an arm that projects from the perimeter wall.

39. An aircraft cabin comprising:
(a) at least two outer rows of passenger compartments on each side of the aircraft cabin, with each row being spaced apart in a length-wise extending direction of the aircraft cabin with the aircraft side walls forming a section of the compartments of each row,
(b) at least one inner row of two adjacent passenger compartments, and
(c) at least two aisles extending in the length-wise extending direction and separating the compartments in each row so that each compartment is accessible via one of the aisles, and
(d) with each compartment comprising walls that define a compartment space and a doorway that allows access to the compartment space from one of the aisles, with each compartment at least comprising a chair for a passenger that is configured to function as a chair and as a bed, and with the walls along the aisles being outwardly curved walls that form an area between the chair and the doorway on which a passenger can stand when the chair is in a bed configuration.

40. The aircraft cabin of claim 39 wherein each compartment includes a door that is movable between a closed position in which the door extends across and closes the doorway and an open position in which the door is away from the doorway.

41. The aircraft cabin of claim 39 wherein the doorways of the compartments on opposite sides of the aisles are not aligned whereby the doorways face the doorway walls on opposite sides of the aisles.

42. The aircraft cabin of claim 29 comprising a plurality of passenger compartments including at least one double bed passenger compartment, with the double bed compartment being defined by a perimeter wall having two openings to allow access to and from the double bed compartment and comprising the pair of passenger chairs positioned side-by-side adjacent each other; and an upright privacy screen which is movable between (i) a retracted position in which the privacy screen is stowed at least substantially outside the double bed compartment so that passenger movement in the compartment is not restricted by the privacy screen and (ii) a deployed position in which the privacy screen is in the double bed compartment between the passenger chairs and divides the compartment into two separate individual passenger compartments, with the privacy screen forming a common wall between the separate individual compartments, and with each separate individual compartment being accessible via one of the openings.

43. The aircraft cabin of claim 39, wherein:
the two adjacent passenger compartments of the at least one inner row, form a double bed passenger compartment comprising a perimeter wall having two openings to allow access to and from the double bed compartment, two passenger chairs positioned side-by-side adjacent each other, and an upright privacy screen which is movable between (i) a retracted position in which the privacy screen is stowed at least substantially outside the double bed compartment so that passenger movement in the compartment is not restricted by the privacy screen and (ii) a deployed position in which the privacy screen is in the double bed compartment between the passenger chairs and divides the compartment into two separate individual passenger compartments, with the privacy screen forming a common wall between the separate individual compartments, and with each separate individual compartment being accessible via one of the openings.

44. The aircraft cabin of claim 43, wherein the perimeter wall includes a cavity that is positioned rearwardly of the passenger chairs for receiving and thereby stowing the privacy screen in the retracted position.

45. The aircraft cabin of claim 43, wherein the privacy screen comprises a plurality of upright panels that can move independently of each other between retracted and deployed positions.

46. The aircraft cabin of claim 43, wherein the privacy screen extends to the height of the perimeter wall adjacent the privacy screen.

47. The aircraft cabin of claim 43, wherein the double bed passenger compartment includes at least one rail for supporting and guiding the privacy screen for movement between the retracted and deployed positions between the passenger chairs.

48. The aircraft cabin of claim 43, wherein the privacy screen is an electrically operable privacy screen.
